(19) United States
(12) Patent Application Publication
(10) Pub. No.: US 2024/0149279 A1
(43) Pub. Date: May 9, 2024

(54) FREE-FLYING CENTRIFUGE SYSTEMS AND METHODS

(71) Applicant: Purdue Research Foundation, West Lafayette, IN (US)

(72) Inventors: D. Marshall Porterfield, Lafayette, IN (US); Madelyn Julia Whitaker, Crown Point, IN (US); Alessandro Jesus Paz Hernández, Weston, FL (US); Autumn Frances Wuebben, Woodbury, MN (US); Kyra Rose Keenan, Middleton, WI (US); Mitchell R. Hekstra, West Lafayette, IN (US); Dominic Lovisa, Granger, IN (US); Ajay Dalal, North Brunswick Township, NJ (US); William Schoenfeld, Wellesley, MA (US); Hunter Moyer, Georgetown, KY (US); Ethan Fry, Brownsburg, IN (US)

(21) Appl. No.: 18/387,122

(22) Filed: Nov. 6, 2023

Related U.S. Application Data
(60) Provisional application No. 63/422,479, filed on Nov. 4, 2022.

(51) Int. Cl. B04B 9/00; B04B 5/04

(52) U.S. Cl. CPC B04B 9/00; B04B 5/0414

(57) ABSTRACT

Centrifuge systems including free-flying centrifuges for mass separations in high gravity, microgravity, or zero gravity environments are described. A centrifuge system includes a body and a rotary member. The body includes a first vertical thruster selectively operable to move the body in a first direction parallel to the central axis, and one or more position sensors configured to determine a position of the body within an open space. The rotary member is configured to receive one or more material samples. The rotary member or body includes a first horizontal thruster selectively operable to move the body in a first direction perpendicular to the central axis, and the rotary member includes a rotational thruster selectively operable to rotate the rotary member about the central axis.

### CROSS-REFERENCE TO RELATED APPLICATIONS

This application is related to and claims the priority benefit of U.S. Provisional Patent Application No. 63/422,479, entitled “Free-Flying Centrifuge Systems and Methods,” filed Nov. 4, 2022, the contents of which are hereby incorporated by reference in their entirety into the present disclosure.

### TECHNICAL FIELD

The present application relates to centrifuges, and specifically to free flying centrifuges operable to separate materials based on mass within microgravity and spaceflight environments.

### BACKGROUND

This section introduces aspects that may help facilitate a better understanding of the disclosure. Accordingly, these statements are to be read in this light and are not to be understood as admissions about what is or is not prior art.

A centrifuge is a device that uses centrifugal force to separate various components of a fluid sample. This is achieved by spinning the fluid at high speed within a container, thereby separating fluids of different densities (e.g., cream from milk) or liquids from solids. It works by causing denser substances and particles to move outward in the radial direction. At the same time, objects that are less dense are displaced and move to the center. In a laboratory centrifuge that uses sample tubes, the radial acceleration causes denser particles to settle to the bottom of the tube, while low-density substances rise to the top. A centrifuge can be a very effective filter that separates contaminants from the main body of fluid.

Existing centrifuge technology approaches for separating components of fluids in microgravity and spaceflight (e.g., zero gravity) environments are commonly based on the mass of the components, where centrifugal force is used to create an artificial accelerative force on the components equivalent to gravity. Centrifuge technology also typically uses electrical motors (e.g., powered by alternating current power supplies, direct current power supplies, stepper power supplies, and the like) where a stator and rotor are used to create electromagnetic forces to accelerate the rotating centrifuge head. These components often possess considerable mass themselves as electric motors require permanent magnets and coiled wire, usually aligned along a central axis that is mechanically stabilized relative to the motor.

Accordingly, aspects of the present disclosure overcome existing limitations of mass and logistics for separations of fluid samples using centrifugal forces while in microgravity and spaceflight environments.

### SUMMARY

Aspects of this disclosure describe centrifuge systems including free-flying centrifuges for mass separations in microgravity or spaceflight environments. However, the centrifuge systems described herein may also be utilized in higher gravity environments, such as on Earth.

Specifically, the present disclosure includes aspects which can include a centrifuge and one or more thrusters. The centrifuge can be configured to receive one or more material samples, and the one or more thrusters can be configured to apply a force on the centrifuge operable to float the centrifuge into free flight within an open space. The one or more thrusters can be selectively operable to apply varying forces on the centrifuge operable to adjust a position of the centrifuge within the open space. In some versions, the centrifuge can define a central rotational axis, wherein the one or more thrusters can be selectively operable to generate a rotational spin of the centrifuge about the central rotational axis.

In some versions, centrifuge systems can include a body having a first vertical thruster which is selectively operable to move the body in a first direction parallel to the central axis. The body can also include one or more position sensors which can be configured to determine a position of the body within an open space. Additionally, the centrifuge system can include a rotary member which can be movably coupled with the body and configured to receive one or more material samples. The rotary member or the body can include a first horizontal thruster which can be selectively operable to move the body in a first direction perpendicular to the central axis, and the rotary member can further include a rotational thruster which can be selectively operable to rotate the rotary member about the central axis. In some versions, the centrifuge system can further include a second vertical thruster coupled with the body and selectively operable to move the body in a second direction parallel to the central axis, or a second horizontal thruster coupled with the rotary member and selectively operable to move the body in a second direction perpendicular to the central axis.

In some embodiments, the centrifuge system can include one or more braking members coupled with the rotary member and configured to selectively brake the rotation of the rotary member relative to the body. The one or more braking members can be translatable between a first position and a second position. In the first position, each braking member can contract against a surface of the rotary member, and in the second position, each braking member can extend a distance away from the surface of the rotary member.

In other embodiments, the rotary member can include one or more bore holes accessible from an inward facing surface of the rotary member. Each of the one or more bore holes can be shaped to receive a material sample tube therein.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of one exemplary free-flying centrifuge system;

FIG. 2 depicts an exemplary software code script for determining a reasonable size for a centrifuge; and

FIG. 3 a depicts a front view schematic diagram of another exemplary free-flying centrifuge system, showing the braking members in a retracted position;

FIG. 4 depicts a side view schematic diagram of the free-flying centrifuge system of FIG. 3, showing the braking members in a retracted position; and

FIG. 5 depicts a top view schematic diagram of the free-flying centrifuge system of FIG. 3, showing the braking members in an extended position.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The advantage of spaceflight and microgravity environments is that the masses of materials can more easily be moved and manipulated relative to the standard gravitational environments on Earth. Aspects of the present disclosure provide various features to overcome limitations of electrical motor-based centrifuges by operating the centrifuge head as a free-flyer in microgravity or spaceflight environments, therefore free of the traditional motor-based approached for rotating the centrifuge head mass. More specifically, the advantageous centrifuge of the present disclosure is configured to use micro-thrusters to fly and control the position of the centrifuge in three-dimensional space. Accordingly, the centrifuge systems described herein may be used for any mass separations or applications where accelerative force is required, such as in materials processing, bio fermentation, biomedical, cell biology, water purification, or any other biological, or non-biological separations. The centrifuge system can further be modified to include temperature, atmospheric, and other environmental controls required by the sample. Still further, the centrifuge system can be configured to include optional subsystems such as sensors, data collectors, and/or data processors as may be typically included in traditional centrifuged systems.

More specifically, micro-thrusters may be configured to adjust the rotation of the free flying centrifuge in real-time such that the rotation and acceleration of the centrifuge is controlled as desired by the operator or as required by the materials being separated. Accordingly, the force of artificial acceleration may be applied in a dose-like manner. Rotational rates could then allow for the controlled application of accelerative gravitational forces ranging from 0.0 G (gravitational force equivalent, or g-force) to any theoretical level including, moon, mars, and Earth normal gravity levels. Higher artificial gravity levels would only be limited by the rate of rotation. Earth normal gravity levels can be achieved with a radius of approximately one meter, and approximately 60 RPMs.

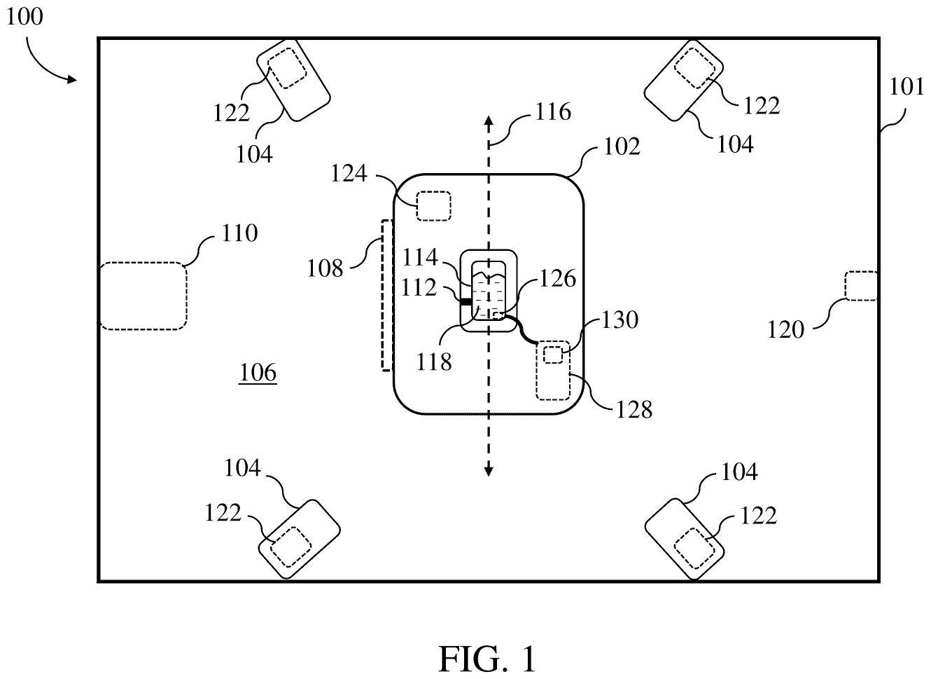

As shown in FIG. 1, one improved centrifuge system (100) can include various components, such as a centrifuge (102) within an enclosure (101) and one or more thrusters (104) coupled with the enclosure (101) and configured to apply forces operable to float and spin (or “free fly”) the centrifuge (102) within an open space (106). The centrifuge system (100) may further include a power system (108) coupled with the centrifuge (102) for selectively powering the centrifuge (102) during operation. In some versions, the power system may be configured to receive solar energy so that the device can be powered or re-powered remotely even while rotating. In other versions, the power system (108) may be configured to wirelessly receive electrical energy from a transmitter (110), such as an optical power transmitter or an electromagnetic inductor (i.e., the transmitter (110) may include a magnet, while the power system (108) may include a coil, or vice versa). In some versions, the power system (108) may be powered by batteries capable of being remotely recharged via an offset energy coupling approach based on solar or other electromagnetic transducers.

The centrifuge (102) may also include a mechanical member (112), such as a ring or arm, to hold a sample tube (114) at a specific distance from the central axis (116), flight, or positioning control systems. Specifically, the mechanical member (112) may be selectively operated to displace the sample tube (114) in a direction perpendicular to the central axis (116) as will be described in greater detail below. As shown, the sample tube (114) holds a material sample (118) for experimentation.

The centrifuge (102) includes a mechanical body structure having sufficient material design and structure as to position samples relative to the center of rotation. It should be understood that centrifuges having different mechanical structures may be required depending on the requirements of the samples, while still incorporating features as described here. As described above, the centrifuge (102) is fly-able via the thrusters (104) such that it can maintain one or more particular positions relative to the working environment (106). In some versions, the thrusters (104) (e.g., micro-thrusters) are powered by compressed gas or by controlled combustion, however additional known methods of powering thrusters (104) may instead be utilized. If operated inside of a cabin, such as a crewed cabin, the thruster fuel may simply be compressed cabin air, or a compressed CO₂ cartridge. Compressed air pumps can be operated within the centrifuge to refill the stores even while rotating. Positioning of the centrifuge (102) relative to the working environment (106) can be accomplished using a sensor (120) and one or more controllers (122) in communication with each other. The sensor (120) may be an optical sensor, and the controllers (122) may be open-loop or closed-loop controllers configured to receive an output signal from the sensor (120) and direct the thrusters (104) as required to adjust the movement of the centrifuge (102). While multiple controllers (122) are shown, in other embodiments only one controller (122) may be communicatively coupled with the thrusters (104) to direct the output of the thrusters (104). Alternatively, in other versions, the sensor (120) may be an RFID or radio triangulation sensor configured to determine and control the position via the controllers (122).

Further, a gyroscope (124) may also be coupled with the centrifuge (102). The gyroscope (124) can be configured to determine an orientation or angular velocity of the centrifuge (102) within the open space (106) and communicate readings to the controllers (122). The determination of the orientation or the inertial guidance may be used for operational stability, such as by communicating with the controller (122) or another control mechanism.

In some versions, the sensor (120) may position the centrifuge (102) within the enclosure (101) via ultrasonic sensing. By utilizing ultrasonic sensing methods as a means of proprioception, the centrifuge system (100) can self-orient and stabilize the centrifuge (102) in a free-flying manner while conducting experiments. Ultrasonic sensing can also allow for more accurate and efficient corrections regarding the overall stability and positioning of the centrifuge (102). In some embodiments, the enclosure (101) may simply include one or more brackets positioned adjacent to the centrifuge (102) for coupling the various components (e.g., the thrusters (104), transmitter (110), and/or sensor (120)) within open space near the centrifuge (102) and the enclosure (101) need not “enclose” the centrifuge system (100).

Within the centrifuge system (100), the force of gravity may be controlled by one or both of two methods, including by physical positioning and by rotation. Regarding physical positioning, adjusting the placement of the centrifuge sample tubes (e.g., using the mechanical member (112)) relative to the central axis (116) can affect the gravitational force on the sample (118) as the distance from the central axis (116) and gravitational effects are directly correlated. Regarding rotation, the force of gravity on the experimental sample (118) may be modified by varying the rotations per minute axially about a rotational axis parallel to the central axis (116). For example, the gravitational force on the sample can be increased by increasing the rotational speed or decreased by decreasing the rotational speed. Notably, in some versions of the centrifuge systems described herein, the centrifuge may be operable to expose biological samples from approximately 0.1 to 2 Gs in increments of 0.1 G.

In microgravity environments, the spin of mass may be controlled such that the rotational rate can determine the force of gravity equivalent acceleration. Within the centrifuge (102) of the centrifuge system (100) described above, rotating mass materials can be re-aligned, re-positioned, and separated by the applied accelerative force so as to separate those materials based on mass similar to traditional centrifuge systems. Advantageously, these experiments can be accomplished in microgravity environments using the spacecraft flight control principles described above being applied to the operation of a laboratory or material processing scale centrifuge system without the need for any traditional electrical motor components. As such, the mechanical subsystems described herein require less maintenance, and provide greater long-term reliability, since traditional electrical motor components are the most common cause for failure.

In operation, the sample tube (114) (e.g., chambers or holders) within the centrifuge (102) may first be filled with an experimental sample (118). Next, the operational position, the desired gravitational rotation rate, and the time frame of the exposure may each be assigned. Aside from the most basic technology configuration for basic mass separations, the control of the rate and timing of gravitational force exposure may be the primary means of adjusting and controlling the operations.

Specialized operations for biological research may be required in some circumstances. To fulfill the need for expanded biological data beyond the reference point of Earth's gravity, a free-flying centrifuge that separates particles by mass may be configured such that it is able to utilize solar energy, conduct work autonomously, and return sensing data for samples in experiments to be conducted. A free-flying centrifuge, navigated via carbon dioxide thrusters, may be configured in a symmetrical diamond-like shape with blunt ends such that it is aerodynamic for flight. It may further optionally contain internal sensors and a processing component each configured to sense and return data on carbon dioxide levels, temperature, and/or pressure. The centrifuge system (100) may in some versions also contain an internal gyroscope, similar to gyroscope (124), to maintain stability during flight, which can function on both Earth and in space. The central axis, similar to central axis (116), can also be a point of adjustment to simulate varying gravitational force levels, done so by placing sample cells at varying radii (i.e., distances) from the central axis. The variance of rotations per minute (RPMs), combined with the sample location from the central axis of the centrifuge, can be utilized to simulate varying gravitational force levels so that data can be gathered on the behavior of biological materials at a plurality of gravitational force levels above and below that of Earth's.

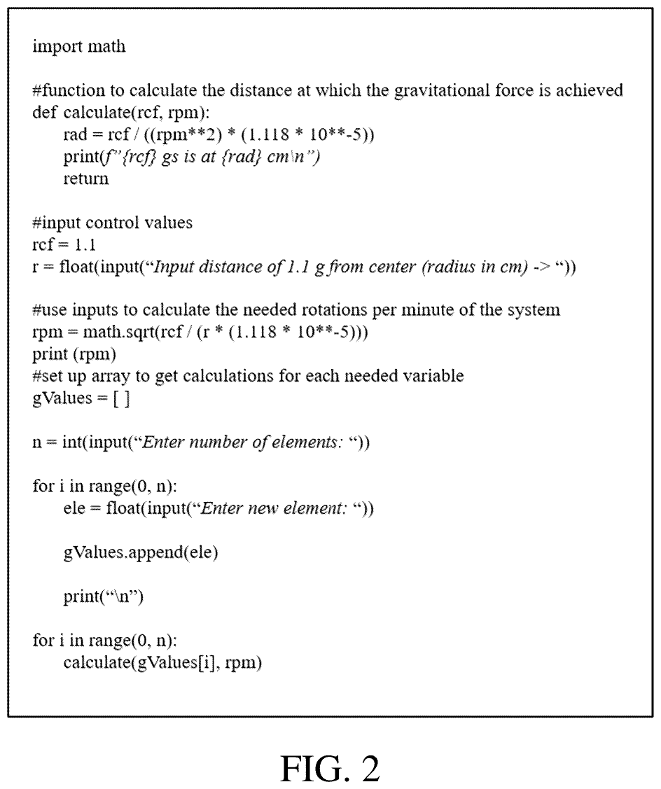

Depicted in FIG. 2 and supplemented by the equations shown in Table 1 below is one example of software code that may be used to determine a reasonable size for the centrifuge (102). The controlled force of 1.1 RCF and the maximum radius of the device may be used to determine the RPMs of the system to create that force in the cell at that distance. This RPM value may then be used to work backwards and determine the distances at which other slots should be to have the desired RCF of force applied. However, it should be understood that the software code and equations merely describe one example method to determine a reasonable centrifuge (102) size and is not intended to be limiting.

TABLE 1
Equations for Determining Centrifuge Size
Equations

RCF = 1.12 × Radius × (RPM/1,000)²
RCF = Relative Centrifugal Force (G Force)
RPM = Rotations Per Minute

In some versions, the centrifuge system (100) is further configured for controlling the temperature of the samples (118). The device may therefore contain one or more temperature sensors (126) in contact with the material sample (118) or sample tube (114) and temperature control mechanisms (128) configured to maintain the internal temperature of the centrifuge (102) and/or the tube (114) holding the samples (118) at a sustainable level. More specifically, the temperature controller (128) is configured to selectively heat or cool the samples (118) in the centrifuge (102) with a margin of error of approximately 0.1-degrees Fahrenheit.

Further, in some versions, the centrifuge system (100) may include one or more components (130) operable to flash-freeze the samples such that the samples are able to be transported to the ground (i.e., into an environment outside of the centrifuge system, such as on the ground on Earth) for analysis after spaceflight. In some versions, liquid nitrogen may be stored within the component (130) or centrifuge (102) itself for selective transport toward the samples (118) for flash (or “snap”) freezing the sample (118).

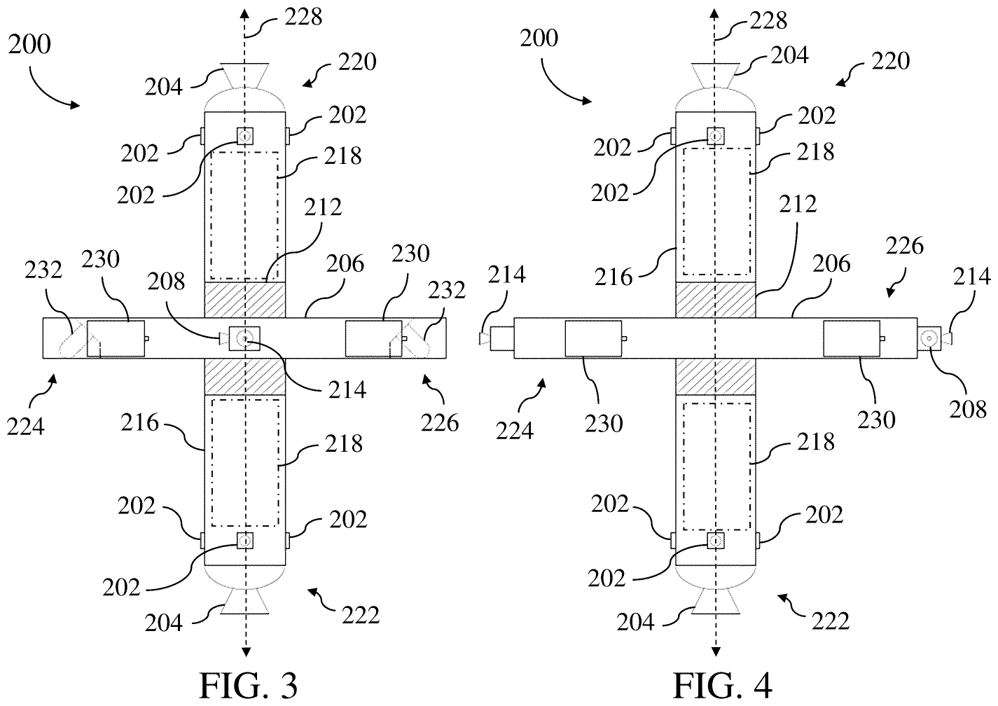

FIGS. 3-5 show another exemplary centrifuge system (200) which can be configured to perform similar functions as centrifuge system (100). Centrifuge system (200) includes various components such as one or more position sensors (202), vertical position thrusters (204), a centrifuge rotor (206), rotational thrusters (208) configured to rotate the centrifuge rotor (206), one or more structural supports (210) for the centrifuge rotor (206), an electronics compartment (212), horizontal position thrusters (214), and a central body (216) which may include one or more inner cavities (218) therein.

More particularly, to assist with free-flying, the position sensors (202) may be positioned anywhere on an exterior-facing surface of the central body (216), such as on opposing ends (220, 222). In some embodiments, the system (200) can include a plurality of position sensors (202) at each end (220, 222), for example, four position sensors (202) at each end (220, 222). The position sensors (202) can be any form of sensor configurable to monitor the position of the system (200) within an open space and to detect surfaces or objects near or within a flight path of the system (200). In some embodiments, the position sensors (202) may be ultrasonic sensors, LiDAR sensors, or a combination thereof.

To power the flight path of the system (200) through open space, vertical position thrusters (204) and horizontal position thrusters (214) are each selectively operable to act to guide the system (200) in respective vertical and horizontal directions. For example, to fly the system (200) in an upward vertical direction, the vertical position thruster (204) at the lower end (222) of the system (200) would be activated. Similarly, to fly the system (200) in a downward vertical direction, the vertical position thruster (204) at the upper end (220) of the system (200) would be activated. To fly the system (200) in a leftward horizontal direction, the horizontal position thruster (214) at the righthand end (226) would be activated, or to fly the system (200) in a rightward horizontal direction, the horizontal position thruster (214) at the lefthand end (224) would be activated. Further, as will be described in greater detail below, the rotor (206) is operable to rotate around the central body (216) (i.e., about the longitudinal axis (228) defined by the central body), thus repositioning each horizontal thruster (214) relative to the central body (216). Accordingly, the rotor (206) may be selectively rotated to reposition the horizontal thrusters (214) before or during their activation to horizontally drive the system (200) in any desirable horizontal direction or path. In some embodiments, the horizontal thrusters (214) are coupled with a surface of the central body (216) as opposed to the rotor (206).

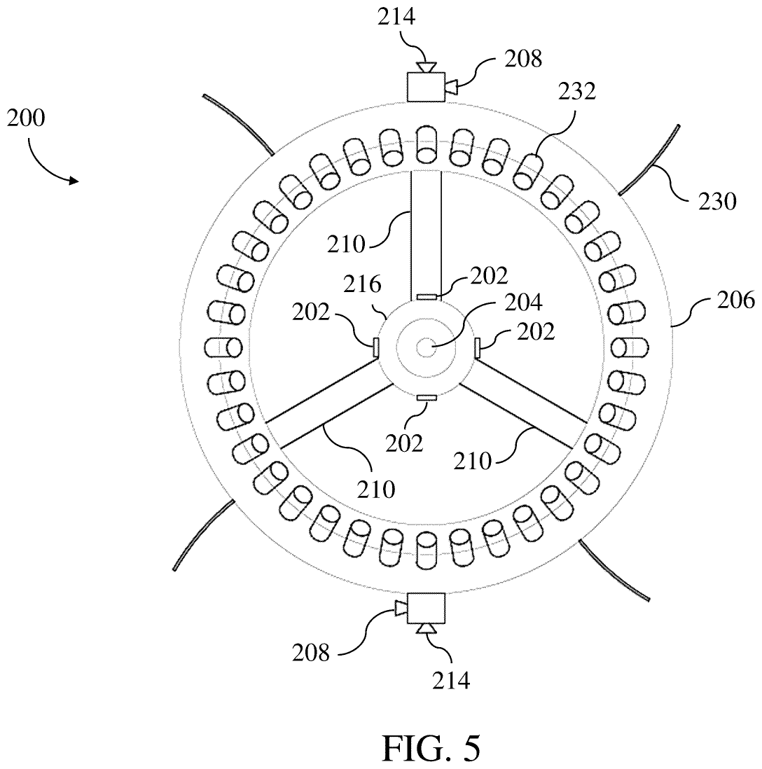

The rotor (206) is configured to movably couple with the main body (216) such that translation of the rotor (206) about the longitudinal axis (228) exerts a centrifugal force onto any material sample(s) coupled to or held within the rotor (206). As shown in FIG. 5, the rotor (206) includes one or more structural supports (210) which are affixed to the rotor (206) during a flight and are movably coupled with the central body (216), such as by the use of ball bearings or similar mechanisms between the structural supports (210) and the central body (216). One or more rotational thrusters (208) positioned on the rotor (206) may be selectively activated to drive the rotation of the rotor (206) around the central body (216). In some embodiments, the rotor (206) may be formed of a cylindrical structural shape, while in other embodiments the rotor (206) may be formed of a toroidal structural shape. Additionally, the rotor (206) can form as large or small of a radius as necessary to therefore achieve different levels of force on the rotor (206) and any material samples associated with the rotor (206). Still further, in some embodiments, the one or more rotational thrusters (208) can each include a shroud to improve aerodynamics during flight.

In some embodiments, the system (200) can include a braking mechanism to slow the rotational speed of the rotor (206). In one example, the system (200) includes one or more braking members (230) coupled with and selectively extending outwardly from the rotor (206). As shown in FIGS. 3-4, the braking members (230) are operable to retract against the surface of the rotor (206) when not in use. As shown in, FIG. 5, the braking members (230) are operable to extend outward from the rotor (206) when rotational braking is desired. An actuator (not shown) may be activated to electronically or mechanically selectively extend and retract the braking members (230).

To perform the key function of a centrifuge, the rotor (206) includes one or more positions thereon or therein for the attachment of a material sample or a material sample tube. Shown in FIGS. 3-5 are a plurality of bore holes (232) arranged around the circumference of the rotor (206), each bore hole (232) operable to accept a test tube containing a material sample. The bore holes (232) may be accessible either from the outward facing surface (not shown) or the inward facing surface (as shown in FIG. 5) of the rotor (206), may extend only a portion of the way through the rotor (206), or alternatively may extend the entire distance through the rotor (206) so as to be accessible from either side. In alternative embodiments, a material test tube may simply be attached to a surface of the rotor (206) using a brace or bracket. It should be understood that, while the bore holes (232) illustrate one example of a mechanism for attaching one or more material test tubes to the rotor (206), various other mechanisms could be devised to accomplish the same functions of coupling and uncoupling a material test tube with the rotor (206).

The central body (216) may include an electrical compartment (212) anywhere within its structure. As shown, the electrical compartment (212) may be centrally positioned, and one or more air or gas chambers (218) may be positioned elsewhere within the central body (216) structure. The electrical compartment (212) can house, for example, the guidance, navigation, and control (GNC) components, as well as any additional processing devices, digital storage devices, communication devices (e.g., wireless communications modules), sensors, or the like. In some versions, the thrusters (204, 208, 214) are powered by compressed air or gas stored in the chambers (218), however additional known methods of powering thrusters (204, 208, 214) may instead be utilized. If operated inside of a cabin, such as a crewed cabin, the thruster fuel may simply be compressed cabin air, or a compressed CO₂ cartridge.

In one example experimental operation, the centrifuge systems (100, 200) described herein may be configured to run an experiment using yeast as a model organism. Yeast shares notable similarities with the human genome and has a relatively small genome itself, which is important for -omic modeling. The yeast genome is well understood scientifically, Accordingly, focusing the initial design of the centrifuge systems (100, 200) described herein around sampling these cells can provide as one advantageous method of testing and/or tuning the centrifuge systems (100, 200). In this experiment, standard microcentrifuge tubes can be used as sampling devices to contain yeast experiments, and thus, the internal rotor can be affixed with wells that accommodate the required size. In alternative versions, the rotor may be adapted or interchanged to suit other sampling devices or organisms.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A centrifuge system, comprising:
(a) a body defining a central axis, wherein the body includes:
(i) a first vertical thruster selectively operable to move the body in a first direction parallel to the central axis, and
(ii) one or more position sensors configured to determine a position of the body within an open space;
(b) a rotary member movably coupled with the body, wherein the rotary member is configured to receive one or more material samples, wherein the rotary member includes:
(i) a first horizontal thruster selectively operable to move the body in a first direction perpendicular to the central axis, and
(ii) a rotational thruster selectively operable to rotate the rotary member about the central axis.

2. The centrifuge system of claim 1, further comprising a second vertical thruster coupled with the body and selectively operable to move the body in a second direction parallel to the central axis, wherein the second direction parallel to the central axis is opposite from the first direction parallel to the central axis.

3. The centrifuge system of claim 1, further comprising a second horizontal thruster coupled with the rotary member and selectively operable to move the body in a second direction perpendicular to the central axis, wherein the second direction perpendicular to the central axis is opposite from the first direction perpendicular to the central axis.

4. The centrifuge system of claim 1, further comprising one or more braking members coupled with the rotary member and configured to selectively brake the rotation of the rotary member relative to the body.

5. The centrifuge system of claim 4, wherein each of the one or more braking members is translatable between a first position and a second position, wherein in the first position each braking member contracts against a surface of the rotary member, wherein in the second position each braking member extends a distance away from the surface of the rotary member.

6. The centrifuge system of claim 1, wherein the rotary member includes one or more bore holes accessible from an inward facing surface of the rotary member, wherein each of the one or more bore holes is shaped to receive a material sample tube therein.

7. A centrifuge system, comprising:
(a) a body defining a central axis;
(b) a rotary member movably coupled with the body, wherein the rotary member is configured to receive one or more material samples;
(c) a first vertical thruster selectively operable to move the body in a first direction parallel to the central axis;
(d) a first horizontal thruster selectively operable to move the body in a first direction perpendicular to the central axis;
(e) a rotational thruster selectively operable to rotate the rotary member about the central axis; and
(f) one or more braking members configured to selectively brake the rotation of the rotary member relative to the body.

8. The centrifuge system of claim 7, further comprising one or more position sensors coupled with the body and configured to determine a position of the body within an open space.

9. The centrifuge system of claim 7, further comprising a second vertical thruster coupled with the body and selectively operable to move the body in a second direction parallel to the central axis, wherein the second direction parallel to the central axis is opposite from the first direction parallel to the central axis.

10. The centrifuge system of claim 7, further comprising a second horizontal thruster coupled with the rotary member and selectively operable to move the body in a second direction perpendicular to the central axis, wherein the second direction perpendicular to the central axis is opposite from the first direction perpendicular to the central axis.

11. A centrifuge system, comprising:
(a) a centrifuge configured to receive one or more material samples;
(b) a plurality of thrusters positioned adjacent to the centrifuge, wherein the plurality of thrusters are configured to apply a force on the centrifuge operable to float the centrifuge into free flight within an open space, wherein the plurality of thrusters are selectively operable to apply varying forces on the centrifuge operable to selectively adjust a position of the centrifuge within the open space.

12. The centrifuge system of claim 11, wherein the centrifuge defines a central rotational axis, wherein the plurality of thrusters are selectively operable to generate a rotational spin of the centrifuge about the central rotational axis.

13. The centrifuge system of claim 11, wherein the plurality of thrusters are operable using compressed air.

14. The centrifuge system of claim 11, wherein the plurality of thrusters are operable using compressed gas.

15. The centrifuge system of claim 11, wherein the plurality of thrusters are operable using a controlled combustion reaction.

16. The centrifuge system of claim 11, further comprising:
(a) a sensor operable to sense the position of the centrifuge within the open space and generate an output signal indicative of a sensed position; and
(b) a controller configured to receive the output signal from the sensor and manipulate the plurality of thrusters to adjust the position of the centrifuge within the open space.

17. The centrifuge system of claim 16, wherein the sensor is configured for optical sensing of the position of the centrifuge within the open space.

18. The centrifuge system of claim 16, wherein the sensor is configured for RFID-based or radio-based triangulation sensing of the position of the centrifuge within the open space.

19. The centrifuge system of claim 11, further comprising a gyroscope coupled with the centrifuge, wherein the gyroscope is configured to determine an orientation or angular velocity of the centrifuge within the open space.

20. The centrifuge system of claim 11, further comprising a power system coupled with the centrifuge, wherein the power system is configured to provide power to the centrifuge while the centrifuge is in free flight within the open space.
